(19) United States
(12) Patent Application Publication
(10) Pub. No.: US 2023/0281273 A1
(43) Pub. Date: Sep. 7, 2023

(54) RELIABILITY JUDGMENT SYSTEM, JUDGMENT DEVICE, METHOD AND PROGRAM

(71) Applicant: Nippon Telegraph and Telephone Corporation, Tokyo (JP)

(72) Inventors: Yoshiaki Shoji, Musashino-shi, Tokyo (JP); Hiroshi Yoshida, Musashino-shi, Tokyo (JP); Masanobu Sakamoto, Musashino-shi, Tokyo (JP); Tomoko SHIBATA, Musashino-shi, Tokyo (JP)

(21) Appl. No.: 18/008,349

(22) PCT Filed: Jun. 12, 2020
(86) PCT No.: PCT/JP2020/023224

§ 371 Date: Dec. 5, 2022

(51) Int. Cl. G06F 17/40; G01M 1/12

(52) U.S. Cl. CPC G06F 17/40; G01M 1/122

(57) ABSTRACT

A reliability determination system according to an embodiment of the present disclosure includes a measurement unit, a determination unit, and a storage unit. The measurement unit measures a movement of a center of gravity of an operator who inputs data. The determination unit determines the reliability of the input data using a result of the measurement of the movement of the center of gravity of the operator inputting the data. The storage unit stores the reliability in association with the input data.

### TECHNICAL FIELD

The present invention relates to a reliability determination system, a determination device, a method, and a program for determining a reliability of data input by an operator.

### BACKGROUND ART

There is a system for checking by an evaluator whether data input by an operator is correct. This system stores data input to an input device by the operator in a database via a network. The evaluator checks the input data read from the database and determines whether the input data is correct for each input item.

### SUMMARY OF THE INVENTION

### Technical Problem

[PTL 1] JP 2005-157590 A

### SUMMARY OF THE INVENTION

### Technical Problem

The system as described above needs to confirm one by one by the evaluator whether the input data is correct from the content of entered data with respect to one item at a time. This causes a problem that the number of operations of the evaluator becomes large, and the evaluator is burdened with checking the data that comes up every day. Thus, it is necessary to reduce the burden of the evaluator.

The present disclosure has been made in view of the above circumstances, and an object of the present disclosure is to provide a reliability determination system, a determination device, a method, and a program which are capable of reducing a time required for the evaluator to evaluate the input data.

### Means for Solving the Problem

In order to achieve the above object, a reliability determination system according to an embodiment of the present disclosure includes a measurement unit, a determination unit, and a storage unit. The measurement unit measures a movement of the center of gravity of an operator who inputs data. The determination unit determines a reliability of input data, using a result of the measurement of the movement of the center of gravity of the operator inputting the data. The storage unit stores the reliability in association with the input data.

### Effects of the Invention

According to the present disclosure, a time required for the evaluator to evaluate input data can be reduced.

### BRIEF DESCRIPTION OF DRAWINGS

FIG. 1 is a block diagram illustrating an example of a reliability determination system according to an embodiment of the present disclosure.

FIG. 2 is a view illustrating an example of a measurement device according to the embodiment.

FIG. 3 is a flowchart illustrating an example of an operation of a determination device according to the embodiment.

FIG. 4 is a table illustrating an example of data stored in a database according to the embodiment.

FIG. 5 is a flowchart illustrating an example of an operation of a determination device according to a modification example of the embodiment.

FIG. 6 is a table illustrating an example of a state in which reliability is updated through reliability determination processing according to the modification example of the embodiment.

### DESCRIPTION OF EMBODIMENTS

Hereinafter, a reliability determination system, a determination device, a method, and a program according to an embodiment of the present disclosure will be described in detail with reference to the drawings. In the following description, component elements having substantially the same functions and configurations are denoted by the same reference signs, and repeated description will be given only when necessary.

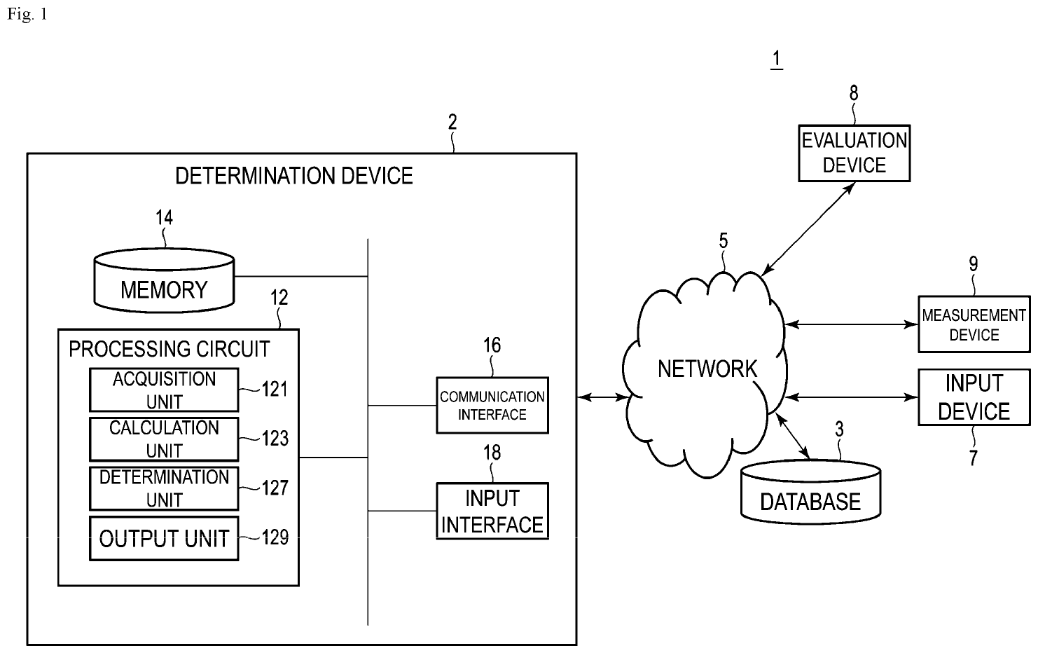

FIG. 1 is a diagram illustrating a configuration of a reliability determination system 1 according to an embodiment of the present disclosure. The reliability determination system 1 includes a determination device 2, a database 3, an input device 7, an evaluation device 8, and a measurement device 9. The determination device 2, the database 3, the input device 7, the evaluation device 8, and the measurement device 9 are connected wirelessly or by wires via a network 5. In the input device 7, data is input by an operator. The measurement device 9 measures the movement of the center of gravity of the operator who inputs the data. The determination device 2 determines the reliability of the data that has been input (hereinafter referred to as input data) using the measurement result of the movement of the center of gravity of the operator inputting the data. The database 3 stores the reliability in association with the input data. The evaluation device 8 notifies the evaluator of the input data and the reliability of the input data. The evaluator can check, by using the evaluation device 8, whether the input data is correct. The operator may be referred to as, for example, a “person who inputs data” or a “person who enters data”. The input data may be referred to as “entered data”.

The input device 7 includes a work display, an input interface, and a communication interface. The input device 7 is a work terminal such as a computer or a tablet. In the input device 7, data is input by an operator for each input item. The input device 7 transmits the input data input by the operator to the database 3 and the determination device 2 via the network 5. The input device 7 is an example of an input unit.

One measurement device 9 is provided to each input device 7. For example, the same number of measurement devices 9 as that of the input devices 7 are provided. The measurement device 9 is, for example, a sensor that is attached to a work tool that is used by the operator to measure information on the movement of the center of gravity of the operator. The work tool is, for example, a chair on which the operator sits. The measurement device 9 measures information on the movement of the center of gravity of the operator who inputs data in the corresponding input device 7. The measurement device 9 transmits the measurement information on the movement of the center of gravity of the operator to the database 3 and the determination device 2 via the network 5. The measurement device 9 is an example of a measurement unit. The measurement device 9 will be described below.

The determination device 2 acquires the input data from the input device 7 or the database 3 via the network 5. Further, the determination device 2 acquires, from the measurement device 9 or the database 3 via the network 5, measurement data regarding the movement of the center of gravity of the operator inputting data. The determination device 2 calculates, using the measurement data, the information on the movement of the center of gravity of the operator inputting the data. The determination device 2 determines the reliability of the input data, based on the information on the movement of the center of gravity. The determination device 2 stores the reliability in association with the input data.

Hereinafter, an example in which a center-of-gravity sway area is used as information on the movement of the center of gravity will be described. The center-of-gravity sway area is calculated using, for example, an area defined by an outer shape of a locus of the center of gravity. Because a typical calculating method is used for the center-of-gravity sway area, description thereof will be omitted herein. Further, as the information on the movement of the center of gravity, for example, a maximum value of a swing width of the center-of-gravity locus may be used instead of the center-of-gravity sway area.

Although the determination device 2 will be described hereinafter as a single device executing a plurality of functions, separate devices may execute the plurality of functions. For example, respective functions that are executed by the determination device 2 may be distributed and mounted in different devices.

The database 3 is a database for managing input data. The database 3 stores, for each input item, for example, the input data transmitted from the input device 7, an operator ID, a threshold value that is used for processing in the determination device 2, a center-of-gravity sway area (hereinafter referred to as a “measurement value of the center-of-gravity sway area”) of the operator inputting data, and a reliability of the input data. That is, the database 3 stores the reliability of the input data in association with the input data for each input item. The operator ID is an example of identification information of the operator. The database 3 stores, in association with the operator ID, the center-of-gravity sway area of the operator at a normal time (hereinafter referred to as a “reference value of the center-of-gravity sway area”) as the threshold value that is used in the determination device 2. The database 3 is provided in a cloud server, for example, and can communicate with the determination device 2, the input device 7, and the measurement device 9. The database 3 may be stored in a dedicated server. The database 3 is an example of a storage unit.

The evaluation device 8 includes a display, an input interface, and a communication interface. The evaluation device 8 is, for example, a work terminal such as a computer or a tablet. The evaluation device 8 displays the input data and the reliability of the input data on a display for each input item. The evaluation device 8 is an example of a display unit.

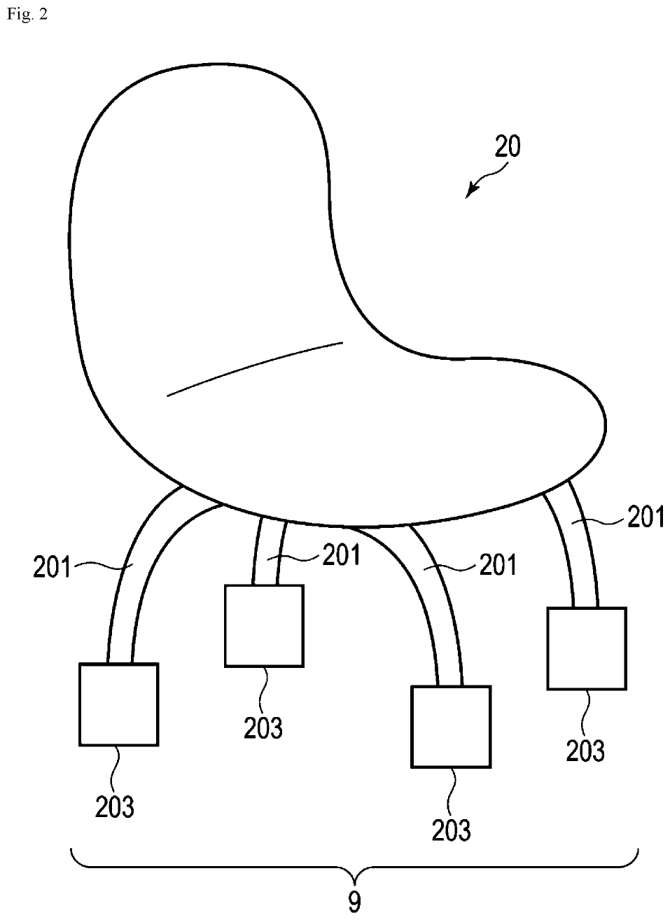

Next, an example of the measurement device 9 will be described with reference to FIG. 2. FIG. 2 is a diagram illustrating an example of the measurement device 9. The measurement device 9 includes a plurality of sensors disposed in a work tool that is used by the operator at the time of inputting data. In FIG. 2, an example in which a plurality of sensors 203 are attached to a chair 20 on which the operator sits will be described.

As illustrated in FIG. 2, the measurement device 9 includes a plurality of sensors 203 provided in the chair 20 on which the operator sits. The sensors 203 are, for example, strain sensors capable of measuring a pressure value. The sensors 203 are distributed and attached such that the center of gravity of the operator can be calculated. The sensors 203 are attached to, for example, tips of respective legs 201 of the chair 20. Each of the sensors 203 acquires a pressure value as a sensor value when the operator sits on the chair 20. The measurement device 9 transmits the sensor values acquired by the respective sensors 203 to the determination device 2.

The measurement device 9 needs to measure the movement of the center of gravity of the operator inputting data. The measurement device 9 may be, for example, one acceleration sensor (motion sensor) attached to a backrest of a chair on which an operator sits or a center-of-gravity sway meter installed under the chair on which an operator sits as described in “A Study of Concentration Ratio Estimation Approach by the Postural Movement Detection for Desk Work, IEICE technical report IMQ 2013-6 (2013-07), Kyosuke Takahashi” and “Development of Estimation System for Concentrate Situation by Using Acceleration Sensor, WISS 2008, Masashi Okubo”.

The determination device 2 acquires the sensor value from the measurement device 9 as a measurement value of the movement of the center of gravity of the operator. The sensor value changes when the operator sits on the chair 20. Thus, the determination device 2 can detect whether the operator is sitting on the chair 20 by acquiring the sensor value from the measurement device 9. Further, the determination device 2 continuously acquires the sensor values from the respective sensors 203 at equal intervals to acquire time-series data. The sensor value changes according to the movement of the center of gravity of the operator. Thus, the determination device 2 can calculate the center-of-gravity sway area of the operator using the time-series data of the sensor value.

Next, an example of a configuration of the determination device 2 will be described. As illustrated in FIG. 1, the determination device 2 includes a processing circuit 12, a memory 14, a communication interface 16, and an input interface 18. The processing circuit 12, the memory 14, the communication interface 16, and the input interface 18 are connected via, for example, a bus.

The memory 14 stores data such as the input data, the sensor values, the center-of-gravity sway area, various threshold values, the operator ID, and the reliability. The memory 14 may be, for example, a commonly used storage medium, such as a hard disk drive (HDD), a solid state drive (SSD), or a flash memory. When the determination device 2 and the database 3 can transmit and receive data via the network 5, the determination device 2 may transmit the data to the database 3 every time the processing circuit 12 acquires and generates the data. In this case, the memory 14 may be a temporary storage medium using a volatile memory such as a cache memory.

The communication interface 16 is an interface for performing data communication with the database 3, the input device 7, and the measurement device 9. For the communication interface 16, a commonly used communication interface may be used.

The input interface 18 is an interface of the determination device 2 for receiving an input from a user. The user of the determination device 2 is, for example, an evaluator for the input data. The input interface 18 is, for example, a mouse, a keyboard, a switch, a button, or a touch panel display.

The processing circuit 12 includes a processor such as a central processing unit (CPU) or an integrated circuit such as an application specific integrated circuit (ASIC). The processing circuit 12 includes an acquisition unit 121, a calculation unit 123, a determination unit 127, and an output unit 129. The acquisition unit 121, the calculation unit 123, the determination unit 127, and the output unit 129 may function as a part of the processor or the integrated circuit when the processor or the integrated circuit executes a processing program.

The acquisition unit 121 acquires the input data input to each input item, the operator ID of the operator who has input data, measurement data indicating the movement of the center of gravity of the operator inputting the data, and a reference value of a center-of-gravity sway area for determining the reliability of input content. The measurement data includes time-series data of measurement values regarding the center-of-gravity sway of the operator. The operator ID, for example, is input to the input interface 18 of the determination device 2 by the operator. A sensor capable of recognizing an ID recognition tag attached to the operator may be attached to a work tool, and an operator ID may be acquired by acquiring a detection defect from the sensor. The reference value of the center-of-gravity sway area is a center-of-gravity sway area of the operator at a normal time, and is used as a threshold value for determining a reliability of the measurement data. The reference value of the center-of-gravity sway area is stored in the database 3 in advance in association with the operator ID. When the acquisition unit 121 acquires each piece of data, the acquisition unit 121 may also acquire data once stored in the database 3 or may directly acquire data from each device via the network 5.

The calculation unit 123 calculates the measurement value of the center-of-gravity sway area using the time-series data of the measurement value regarding the center-of-gravity sway of the operator, the center-of-gravity sway area being the center-of-gravity sway area of the operator inputting data.

The determination unit 127 determines the reliability of the input data using the measurement value of the center-of-gravity sway area. Specifically, the determination unit 127 determines the reliability of the input data using the measurement value of the center-of-gravity sway area and the reference value of the center-of-gravity sway area. In this case, when the measurement value of the center-of-gravity sway area is larger than the reference value of the center-of-gravity sway area, the determination unit 127 determines that the operator is not concentrated because the operator is continuously moving while sitting, and determines that data entered in this period is less reliable. On the other hand, when the measurement value of the center-of-gravity sway area is equal to or smaller than the reference value of the center-of-gravity sway area, the determination unit 127 determines that data entered in this period is highly reliable because the operator is hardly moving and concentrated. Detailed processing of the determination unit 127 will be described below.

The output unit 129 outputs the determined reliability to the database 3 in association with the input data. Thus, the reliability is stored in the database 3 in association with the input data.

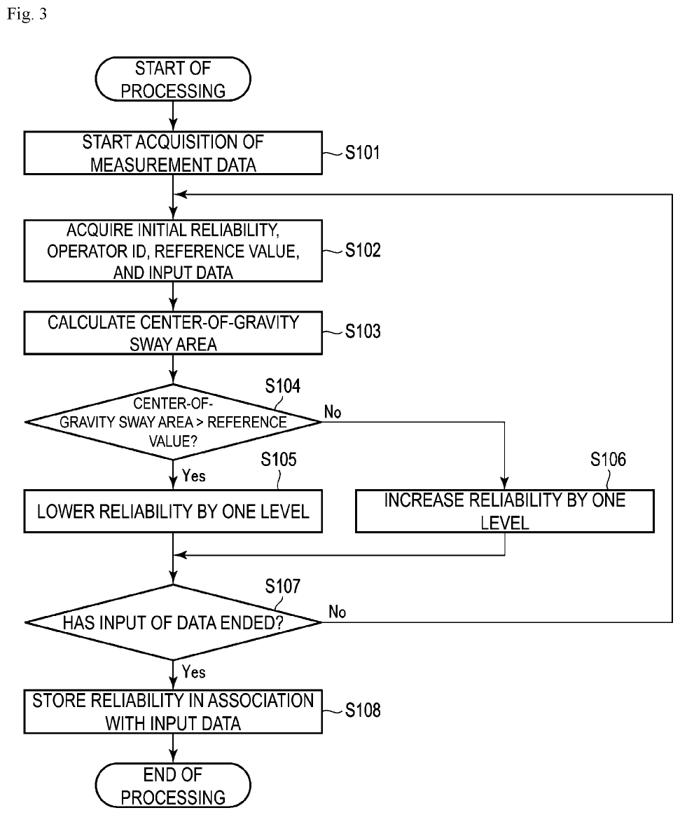

Next, an example of an operation of the reliability determination processing that is executed by the determination device 2 will be described. The reliability determination processing is processing of determining a reliability of input data input to a specific input item. FIG. 3 is a flowchart illustrating an example of a procedure of the reliability determination processing according to the present embodiment. A processing procedure in reliability determination processing to be described below is merely an example, and each processing can be changed appropriately as much as possible. Further, for the processing procedure to be described below, steps can be omitted, replaced, and added appropriately according to the embodiment of the present disclosure.

Here, an example in which three levels “A”, “B”, and “C” are used as the reliability of the input data will be described. The reliability “A” is an index indicating that the reliability of the input data is high. The reliability “C” is an index indicating that the reliability of the input data is low. The reliability “B” is an index indicating that the reliability of the input data is between the reliability “A” and the reliability “C”. The levels of the reliability may be, for example, two levels or may be four or more levels.

### Step S101

When starting to input data to each input item, the input device 7 transmits a signal indicating that the input of the data has been started to the determination device 2 via the network 5. The acquisition unit 121 starts to acquire measurement data regarding the center-of-gravity sway of an operator upon receiving the signal indicating that the input of the data has been started. For example, the acquisition unit 121 acquires the sensor value detected by the sensor 203 as the measurement data from the measurement device 9 over time.

### Step S102

The acquisition unit 121 acquires, for each unit time, the input data input to the input item, the operator ID of the operator who is inputting the data to the input item, the reference value of the center-of-gravity sway area associated with the operator, and initial reliability. The initial reliability is, for example, the reliability “B”. The unit time is, for example, “one minute”. The unit time may be shorter than one minute or may be longer than one minute.

### Step S103

The calculation unit 123 calculates the center-of-gravity sway area of the operator in the unit time, using the measurement data acquired over time. In this case, the calculation unit 123 calculates a change in a position of the center of gravity of the operator in the unit time, using the sensor value that is time-series data sampled at a predetermined interval. The calculation unit 123 calculates the center-of-gravity sway area of the operator in the unit time, using the change in the position of the center of gravity of the operator.

### Step S104

The determination unit 127 determines the reliability of the input data, in accordance with the measurement value of the center-of-gravity sway area and the reference value of the center-of-gravity sway area. In this case, the determination unit 127 first determines whether the measurement value of the center-of-gravity sway area is larger than the reference value of the center-of-gravity sway area. When the measurement value of the center-of-gravity sway area is larger than the reference value of the center-of-gravity sway area (step S104—Yes), the determination unit 127 determines that the center-of-gravity sway area of the operator inputting data is larger than the center-of-gravity sway area of the operator at a normal time. The processing proceeds to step S105. When the measurement value of the center-of-gravity sway area is equal to or smaller than the reference value of the center-of-gravity sway area (step S104—No), the determination unit 127 determines that the center-of-gravity sway area of the operator inputting data is equal to or smaller than the center-of-gravity sway area of the operator at a normal time. The processing proceeds to step S106.

### Step S105

When the measurement value of the center-of-gravity sway area is larger than the reference value of the center-of-gravity sway area (step S104-Yes), the determination unit 127 lowers the reliability by one level. For example, when the current reliability is “B”, the determination unit 127 sets the reliability to “C”. However, when the current reliability is at the lowest level, that is, when the reliability cannot be lowered any further, the reliability is maintained. For example, when the current reliability is “C”, the reliability is maintained at “C”.

### Step S106

When the measurement value of the center-of-gravity sway area is equal to or smaller than the reference value of the center-of-gravity sway area (step S104—No), the determination unit 127 increases the reliability by one level. For example, when the current reliability is “B”, the determination unit 127 sets the reliability to “A”. However, when the current reliability is at the highest level, that is, when the reliability cannot be increased any further, the reliability is maintained. For example, when the current reliability is “A”, the reliability is maintained at “A”.

### Step S107

The processing circuit 12 determines whether input of data in a current input item has ended. In this case, the processing circuit 12 determines whether the input of the data in the current input item has ended, by determining whether the input of the data in the current input item is continued even in the next unit time. When the input of the data ends (step S104—Yes), the processing proceeds to step S108. When the input of the data has not ended, that is, when the input of the data in the input item is continued even in the next unit time (step S104—No), the processing returns to step S102. Then, the processing of steps S102 to S107 is repeated until the input of the data in the input item ends, and the determination of the reliability of the input data in the input item is repeated, thereby updating the reliability each time the unit time elapses.

### Step S108

When the input of the data in the input item ends, the output unit 129 outputs the current reliability as the reliability of the input item to the database 3 in association with the input item and the input data. Thus, the reliability of the input data in the input item is stored in the database 3 in association with the input item and the input data. The processing circuit 12 ends the reliability determination processing for the input data.

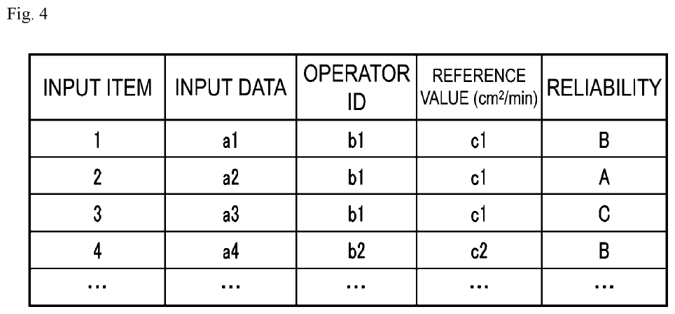

FIG. 4 is a table illustrating an example of data stored in the database 3 through the reliability determination processing. In FIG. 4, the input data, the operator ID, the reference value of the center-of-gravity sway area, and the reliability are stored for each input item. In one example of FIG. 4, for example, the operator ID “b1”, the reference value “c1” of the center-of-gravity sway area, and the reliability “B” are input in association with the input data “a1” input to the input item “1”. When the evaluator evaluates the input data in the evaluation device 8, the evaluation device 8 displays, for example, the input data acquired from the database 3 and the reliability associated with the input data for each input item. In this case, the operator ID and the reference value of the center-of-gravity sway area, in addition to the reliability, may be displayed for each input item.

Next, effects of the reliability determination system 1 according to the present embodiment will be described.

The reliability determination system 1 according to the present embodiment includes the measurement device 9, the determination device 2, and the database 3. The measurement device 9 measures the movement of the center of gravity of the operator inputting the data. The determination device 2 determines the reliability of the input data in accordance with the measurement result of the movement of the center of gravity of the operator inputting the data. The database 3 stores the reliability in association with the input data. Specifically, the database 3 stores the center-of-gravity sway area at a normal time as the reference value of the center-of-gravity sway area, and the determination device 2 calculates the center-of-gravity sway area at the time of inputting data as the measurement value of the center-of-gravity sway area and calculates the reliability of the input data using the reference value of the center-of-gravity sway area and the measurement value of the center-of-gravity sway area.

That is, the reliability determination system 1 according to the present embodiment measures (monitors) the movement of the center of gravity of the operator (data entry person) who inputs the data, and stores the data input by the operator and the reliability obtained from the information on the movement of the center of gravity in association with each other.

Here, it is known that, in desk work, people who concentrate have less body sway, and the sway of the body of people who do not concentrate is large, as described in “A Study of Concentration Ratio Estimation Approach by the Postural Movement Detection for Desk Work, IEICE technical report IMQ 2013-6 (2013-07), Kyosuke Takahashi” and “Development of Estimation System for Concentrate Situation by Using Acceleration Sensor, WISS 2008, Masashi Okubo”. For example, it is possible to determine that data under a situation in which a center of gravity or a foot is constantly moving is less reliable because the data is not described in a concentrated situation.

The reliability determination system 1 according to the present embodiment determines, by using the center-of-gravity sway area per unit time as information on the movement of the center of gravity, that the reliability is high when the measured center-of-gravity sway area per unit time is smaller than the center-of-gravity sway area of the operator at a normal time, and that the reliability is low when the measured center-of-gravity sway area per unit time is larger than the center-of-gravity sway area of the operator at a normal time. Thus, the reliability of the input data can be measured, without using content of the input data, by reflecting the sway of the body of the operator inputting data. In addition, by using the reliability, it is possible to rapidly execute primary sorting of the input data by collectively extracting highly reliable data or less reliable data from among the input data. This makes it possible for an evaluator to extract and confirm data appearing to be unconfident in the input data. That is, the evaluator can selectively present data presumed to be less reliable to efficiently check correctness of the data.

### MODIFICATION EXAMPLE

A modification example of the present embodiment will be described. The modification example is a modification of the configuration of the above-described embodiment as follows. In the modification example, processing of determining the reliability of the input data differs from that of the above-described embodiment. Description of the same configuration, operation, and effects as those of the above-described embodiment will be omitted.

The determination unit 127 determines that the input data is less reliable when the measurement value of the center-of-gravity sway area is larger than the reference value of the center-of-gravity sway area in consecutive unit times and determines that the input data is highly reliable when the measurement value of the center-of-gravity sway area is equal to or smaller than the reference value of the center-of-gravity sway area in the consecutive unit times. The unit time is, for example, a period of one minute.

Specifically, when the measurement value of the center-of-gravity sway area per unit time exceeds the reference value of the center-of-gravity sway area twice in a row, the determination unit 127 determines that the operator is not concentrated because the operator is continuously moving while sitting. In this case, the determination unit 127 determines that data entered in this period is less reliable and lowers the reliability of the input data by one level. On the other hand, in a case in which the measurement value of the center-of-gravity sway area per unit time does not exceed the reference value twice in a row even when the measurement value of the center-of-gravity sway area per unit time exceeds the reference value of the center-of-gravity sway area, the determination unit 127 determines that the operator has sat again or changed his or her posture, and the reliability is maintained at the current level. Further, even when the measurement value of the center-of-gravity sway area per unit time exceeds the reference value of the center-of-gravity sway area, if the reliability of the input item is determined for the first time, the reliability is maintained at the current level.

Further, when the measurement value of the center-of-gravity sway area per unit time is equal to or smaller than the reference value of the center-of-gravity sway area twice in a row, the determination unit 127 determines that the operator is hardly moving and concentrated. In this case, the determination unit 127 determines that data entered in this period is highly reliable and increases the reliability of the input data by one level. On the other hand, even in a case in which the measurement value of the center-of-gravity sway area per unit time is equal to or smaller than the reference value of the center-of-gravity sway area, if the measurement value is not equal to or smaller than the reference value twice in a row or if the reliability in the input item is determined for the first time, the reliability is maintained at the current level.

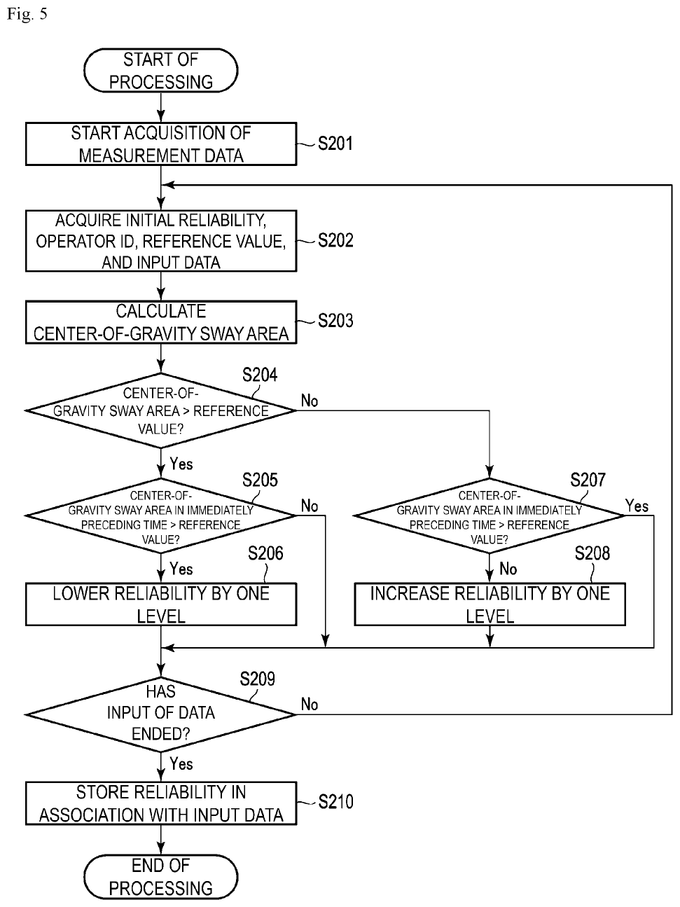

Next, an example of the operation of the reliability determination processing that is executed by the determination device 2 will be described. FIG. 5 is a flowchart illustrating an example of a procedure of the reliability determination processing according to the present modification example. An example in which three levels “A”, “B”, and “C” are used as the reliability of the input data as in the above-described embodiment will be described.

Processing of steps S201 to S203 and steps S209 to S210 in FIG. 5 are the same as the processing of steps S101 to S103 and steps S207 to S208 in the first embodiment, and therefore description thereof will be omitted.

In step S204, the determination unit 127 determines the reliability of the input data in accordance with the measurement value of the center-of-gravity sway area and the reference value of the center-of-gravity sway area. In this case, the determination unit 127 first determines whether the measurement value of the center-of-gravity sway area is larger than the reference value of the center-of-gravity sway area.

When the measurement value of the center-of-gravity sway area is larger than the reference value of the center-of-gravity sway area (step S204—Yes), the determination unit 127 determines that the center-of-gravity sway area of the operator at the time of inputting data is larger than the center-of-gravity sway area of the operator at a normal time. In this case, the determination unit 127 determines whether the center-of-gravity sway area exceeds the reference value of the center-of-gravity sway area twice in a row. Specifically, the determination unit 127 determines whether the measurement value of the center-of-gravity sway area in an immediately preceding time is larger than the reference value of the center-of-gravity sway area (step S205). When the measurement value of the center-of-gravity sway area in the immediately preceding time is larger than the reference value of the center-of-gravity sway area (step S205—Yes), the determination unit 127 determines that the center-of-gravity sway area is larger than the center-of-gravity sway area of the operator at a normal time twice in a row and lowers the reliability by one level (step S206). When the measurement value of the center-of-gravity sway area at the immediately preceding time is equal to or smaller than the reference value of the center-of-gravity sway area (step S205—No), the determination unit 127 maintains the reliability at the current level.

When the measurement value of the center-of-gravity sway area is equal to or smaller than the reference value of the center-of-gravity sway area (step S204—No), the determination unit 127 determines that the center-of-gravity sway area of the operator inputting data is equal to or smaller than the center-of-gravity sway area of the operator at a normal time. In this case, the determination unit 127 determines whether the center-of-gravity sway area is equal to or smaller than the reference value of the center-of-gravity sway area twice in a row. Specifically, the determination unit 127 determines whether the measurement value of the center-of-gravity sway area in the immediately preceding time is larger than the reference value of the center-of-gravity sway area (step S207). When the measurement value of the center-of-gravity sway area in the immediately preceding time is equal to or smaller than the reference value of the center-of-gravity sway area (step S207—No), the determination unit 127 determines that the center-of-gravity sway area is equal to or smaller than the center-of-gravity sway area of the operator in a normal time twice in a row, and increases the reliability by one level (step S208). When the measurement value of the center-of-gravity sway area at the immediately preceding time is larger than the reference value of the center-of-gravity sway area (step S207—Yes), the determination unit 127 maintains the reliability at the current level.

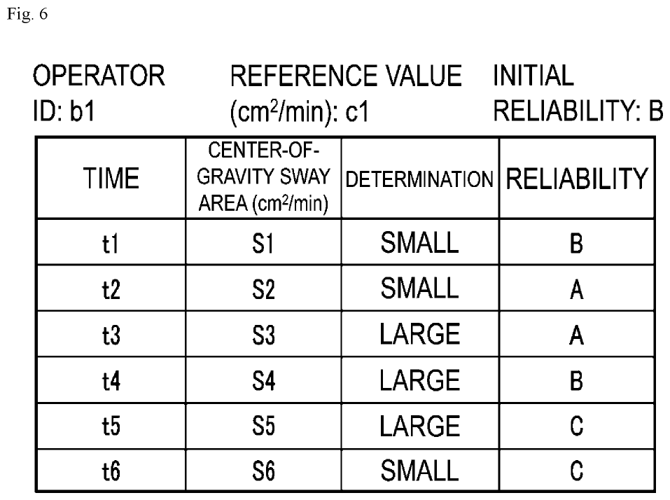

FIG. 6 is a table illustrating an example of a state in which the reliability is updated by repeating processing of steps S202 to S209 according to the modification example. Herein, a case will be described in which the initial reliability is the reliability “B”, the operator ID of the operator who has input the input data to the input item is “b1”, and the reference value of the center-of-gravity sway area of the operator is “c1”. For example, it is assumed that a center-of-gravity sway area S1 of the operator in a unit time t1 is equal to or smaller than a reference value c1 of the center-of-gravity sway area. In this case, because the determination of the reliability is the first time, the reliability of the input data is maintained at the current level “B”. Further, it is assumed that a center-of-gravity sway area S2 of the operator in a unit time t2 is equal to or smaller than the reference value c1 of the center-of-gravity sway area. In this case, because the center-of-gravity sway area is equal to or smaller than the center-of-gravity sway area of the operator at a normal time twice in a row, the reliability of the input data is increased by one level and becomes “A”. Further, it is assumed that a center-of-gravity sway area S3 of the operator in a unit time t3 is larger than the reference value c1 of the center-of-gravity sway area. In this case, because the center-of-gravity sway area does not exceed the center-of-gravity sway area of the operator at a normal time twice in a row, the reliability of the input data is maintained at the current level “A”. Further, it is assumed that a center-of-gravity sway area S4 of the operator in a unit time t4 is larger than the reference value c1 of the center-of-gravity sway area. In this case, because the center-of-gravity sway area is larger than center-of-gravity sway area of the operator at a normal time twice in a row, the reliability of the input data is lowered by one level and becomes “B”.

Hereinafter, effects of a reliability determination system 1 according to the present modification example will be described. In the present modification example, the following effects can be obtained, in addition to the same effects as the effects of the above-described embodiment.

The reliability determination system 1 according to the present modification example determines that the input data is less reliable when the measurement value of the center-of-gravity sway area is larger than the reference value of the center-of-gravity sway area in consecutive unit times, and determines that the input data is highly reliable when the measurement value is equal to or smaller than the reference value in the consecutive unit times.

According to the above configuration, when the center-of-gravity sway area per unit time exceeds the center-of-gravity sway area of the operator at a normal time twice in a row, it is determined that the operator is moving continuously while sitting and is not concentrated, and the reliability of the input data is lowered by one level. On the other hand, when the center-of-gravity sway area per unit time does not exceed the center-of-gravity sway area of the operator at a normal time twice in a row, it is determined that the operator has sat again or changed his or her posture, and the reliability is maintained. Further, when the center-of-gravity sway area per unit time is equal to or smaller than the center-of-gravity sway area of the operator at a normal time twice in a row, it is determined that the operator is hardly moving and concentrated, and the reliability of the input data is increased by one level. On the other hand, when the center-of-gravity sway area per unit time is not equal to or smaller than the center-of-gravity sway area at a normal time twice in a row, the reliability is maintained at the current level. This makes it possible to obtain a reliability more accurately reflecting a status of the operator.

A technical idea of the present application can be executed by a computer, using a program causing the computer to execute instructions in the processing procedures described in the embodiment and modification example above. Further, the technical idea of the present application can also be realized as a program that can be provided via a network. Further, the technical idea of the present application can also be included as a recording medium in which the above program is recorded.

The present invention is not limited to the embodiment as it is, and at an implementation stage, the component elements of the embodiment can be modified and embodied within a range not departing from the gist of the present invention. Further, various inventions can be formed by an appropriate combination of the plurality of component elements disclosed in the above-described embodiment. For example, some component elements may be removed from all the component elements constituting the embodiment. Further, component elements in different embodiments may be combined appropriately.

### REFERENCE SIGNS LIST

1 Reliability determination system
2 Determination device
3 Database
5 Network
7 Input device
8 Evaluation device
9 Measuring device
12 Processing circuit
121 Acquisition unit
123 Calculation unit
127 Determination unit
129 Output unit
14 Memory
16 Communication interface
18 Input interface
20 Chair
201 Leg
203 Sensor
a1 to a4 Input data
b1 to b4 Operator ID
c1 to c4 Reference value
S1 to S4 Center-of-gravity sway area
A to C Reliability
t1 to t4 Unit time

1. A reliability determination system, comprising:
a measurement unit, including one or more processors, configured to measure a movement of a center of gravity of an operator who inputs data;
a determination unit, including one or more processors, configured to determine a reliability of input data using a result of the measurement of the movement of the center of gravity of the operator inputting data; and
a storage unit configured to store the reliability in association with the input data.

2. The reliability determination system according to claim 1, further comprising:
a calculation unit, including one or more processors, configured to calculate, using the measurement result, a measurement value of a center-of-gravity sway area per unit time at a time of inputting data,
wherein the storage unit is configured to store a center-of-gravity sway area of the operator at a normal time as a reference value of the center-of-gravity sway area, and
the determination unit is configured to determine the reliability of the input data in accordance with the measurement value of the center-of-gravity sway area and the reference value of the center-of-gravity sway area.

3. The reliability determination system according to claim 2,
wherein the determination unit
is configured to determine that the input data is less reliable when the measurement value of the center-of-gravity sway area is larger than the reference value of the center-of-gravity sway area, and
determine that the input data is highly reliable when the measurement value of the center-of-gravity sway area is equal to or smaller than the reference value of the center-of-gravity sway area.

4. The reliability determination system according to claim 2,
wherein the determination unit
is configured to determine that the input data is less reliable when the measurement value of the center-of-gravity sway area is larger than the reference value of the center-of-gravity sway area in consecutive unit times, and
determine that the input data is highly reliable when the measurement value of the center-of-gravity sway area is equal to or smaller than the reference value of the center-of-gravity sway area in the consecutive unit times.

5. A reliability determination method, comprising:
measuring a movement of a center of gravity of an operator who inputs data;
determining a reliability of the input data in accordance with a result of the measurement of the movement of the center of gravity of the operator inputting data; and
storing the reliability in association with the input data.

6. The reliability determination method according to claim 5, further comprising:
calculating, by using the measurement result, a measurement value of a center-of-gravity sway area per unit time at a time of inputting data;
storing the center-of-gravity sway area of the operator at a normal time as a reference value of the center-of-gravity sway area; and
determining the reliability of the input data in accordance with the measurement value of the center-of-gravity sway area and the reference value of the center-of-gravity sway area.

7. A determination device comprising:
an acquisition unit, including one or more processors, configured to acquire a measurement result of a movement of a center of gravity of an operator inputting data;
a determination unit, including one or more processors, configured to determine a reliability of input data in accordance with the measurement result; and
an output unit configured to output the reliability in association with the input data.

8. A non-transitory computer-readable storage medium storing a program for causing a computer to execute each unit of the determination device according to claim 7.

9. The determination device according to claim 7, further comprising:
a calculation unit, including one or more processors, configured to calculate, using the measurement result, a measurement value of a center-of-gravity sway area per unit time at a time of inputting data,
wherein the storage unit is configured to store a center-of-gravity sway area of the operator at a normal time as a reference value of the center-of-gravity sway area, and
the determination unit is configured to determine the reliability of the input data in accordance with the measurement value of the center-of-gravity sway area and the reference value of the center-of-gravity sway area.

10. The determination device according to claim 9,
wherein the determination unit
is configured to determine that the input data is less reliable when the measurement value of the center-of-gravity sway area is larger than the reference value of the center-of-gravity sway area, and
determine that the input data is highly reliable when the measurement value of the center-of-gravity sway area is equal to or smaller than the reference value of the center-of-gravity sway area.

11. The determination device according to claim 9,
wherein the determination unit
is configured to determine that the input data is less reliable when the measurement value of the center-of-gravity sway area is larger than the reference value of the center-of-gravity sway area in consecutive unit times, and
determine that the input data is highly reliable when the measurement value of the center-of-gravity sway area is equal to or smaller than the reference value of the center-of-gravity sway area in the consecutive unit times.
